(19) United States
(12) Patent Application Publication
(10) Pub. No.: US 2015/0234197 A1
(43) Pub. Date: Aug. 20, 2015

(54) WAVELENGTH SELECTIVE POLARIZER, OPTICAL SYSTEM, AND PROJECTION-TYPE DISPLAY APPARATUS

(71) Applicant: CANON KABUSHIKI KAISHA, Tokyo (JP)

(72) Inventor: Reona Ushigome, Saitama-shi (JP)

(21) Appl. No.: 14/618,256

(22) Filed: Feb. 10, 2015

(30) Foreign Application Priority Data
Feb. 17, 2014 (JP) 2014-027916

(51) Int. Cl. G02B 27/28; G03B 21/20; G02B 5/30

(52) U.S. Cl. CPC G02B 27/283; G02B 5/3041; G03B 21/2073

(57) ABSTRACT

A wavelength selective polarizer includes a substrate that is transparent to light in a visible wavelength band, and an absorption layer configured of a resin composition in which color materials are dispersed and formed on the substrate. The absorption layer includes a plurality of structures that are structured similarly to one another, the plurality of structures being arranged in a predetermined direction with a period shorter than a shortest wavelength in the visible wavelength band. Where a longitudinal direction of each of the plurality of structures is set to a first direction, the predetermined direction is a second direction that is orthogonal to the first direction and parallel to a surface of the substrate, on which the absorption layer is formed. A material of the absorption layer satisfies the predetermined condition.

### BACKGROUND OF THE INVENTION

1. Field of the Invention

The present invention relates to a wavelength selective polarizer, an optical system, and a projection-type display apparatus.

2. Description of the Related Art

Japanese Patent Laid-Open No. (“JP”) 2006-71761 discloses a projection-type display apparatus that arranges a wavelength selective polarizer configured to absorb light in a blue wavelength band between a polarization beam splitter (“PBS”) configured to emit blue light and red light, and a color combiner. JP 2008-216957 discloses an absorption-type highly durable wavelength selective polarizer in which an inorganic nanoparticle layer and a reflecting layer have a wire grid structure (linear grating structure), and a tenth embodiment of that reference uses an inorganic nanoparticle material. JP 2007-147738 discloses a color filter arranged opposite to each of a plurality of photoelectric conversion areas in a pixel and configured to provide a color separation for each pixel for incident light on the photoelectric conversion area.

The structure of JP 2006-71761 has a low light detection performance in a black or dark display for red light (which is a non-projected state of light), and the red light in the black display transmits through the PBS and is projected, lowering the contrast. Due to leak light (containing a non-rotated polarization component in the red light and a rotated polarization component in the blue light) outside the desired characteristic caused by a wavelength selective phase shifter that is configured to rotate a polarization direction of a specific wavelength band by 90°, the color purity also lowers in a white or bright display (which is a light projecting state).

Along with a demand for a higher brightness, a projection-type display apparatus receives a more intensified radiation heat from a light source, and a wavelength selective polarizer is thus required to be highly durable. The wavelength selective polarizer configured to absorb the blue wavelength band as disclosed in JP 2006-71761 is made of a stretched polymer film containing a dye material. This film is likely to shrink and is less durable to the high radiation heat. In addition, the selecting freedom of a base material is restricted by the manufacturing method of orientation. The wavelength selective polarizer configured to absorb the red wavelength band as disclosed in 2006-71761 has a low transmittance to the light in the blue wavelength band, exhibits an insufficient wavelength selectivity, and is of poor practical use.

Since JP 2008-216957 uses metal or semiconductor for a material for an absorption layer, the wavelength characteristic of the attenuation coefficient does not significantly change in the visible wavelength band and thus the wavelength selectivity is insufficient.

### SUMMARY OF THE INVENTION

The present invention provides an absorption-type wavelength selective polarizer, an optical system, and a projection-type display apparatus, which can have a high durability and a high wavelength selectivity.

A wavelength selective polarizer according to the present invention includes a substrate that is transparent to light in a visible wavelength band, and an absorption layer configured of a resin composition in which color materials are dispersed and formed on the substrate. The absorption layer includes a plurality of structures that are structured similarly to one another, the plurality of structures being arranged in a predetermined direction with a period shorter than a shortest wavelength in the visible wavelength band. Where a longitudinal direction of each of the plurality of structures is set to a first direction, the predetermined direction is a second direction that is orthogonal to the first direction and parallel to a surface of the substrate, on which the absorption layer is formed. A material of the absorption layer satisfies the following condition:

0.1<kmax−kmin<0.5

where kmax is a maximum extinction coefficient obtained to light in a first wavelength band in the visible wavelength band, and kmin is a minimum extinction coefficient obtained to light in a second wavelength band in the visible wavelength band different from the first wavelength band.

Further features of the present invention will become apparent from the following description of exemplary embodiments with reference to the attached drawings.

### BRIEF DESCRIPTION OF THE DRAWINGS

FIGS. 1A, 1B, 1C, and 1D are schematic views each illustrating a structure of a wavelength selective polarizer according to this embodiment.

FIGS. 2A and 2B are schematic views of a modification of the wavelength selective polarizer illustrated in FIG. 1C.

FIG. 3 is a graph for explaining a transition wavelength bandwidth of the wavelength selective polarizer illustrated in FIG. 1A.

FIG. 4A is an optical path diagram of a projection-type display apparatus utilizing one of the wavelength selective polarizers illustrated in FIGS. 1A, 1B, 1C, and 1D, and FIG. 4B is a graph of a transmittance of a color combiner.

FIG. 5 is an optical path diagram of another projection-type display apparatus utilizing one of the wavelength selective polarizers illustrated in FIGS. 1A, 1B, 1C, and 1D.

FIGS. 6A, 6B, and 6C are graphs of transmittances and reflectances of the wavelength selective polarizer illustrated in FIG. 1A according to first, second, and third embodiments.

FIG. 7 is a graph of transmittances and reflectances of a wavelength selective polarizer according to a comparative example.

FIG. 8 is a graph for explaining a structural birefringence of TiO₂ according to a fourth embodiment.

FIG. 9A is a graph of transmittances and reflectances of a thin film according to a fourth embodiment, and FIG. 9B is a graph of transmittances and reflectances of the entire wavelength selective polarizer illustrated in FIG. 1B according to the fourth embodiment.

FIG. 10 is a graph for explaining a structural birefringence of each of TiO₂ and SiO₂ according to fifth and sixth embodiments.

FIG. 11A is a graph of transmittances and reflectances of a multilayer structure according to a fifth embodiment, and FIG. 11B is a graph of transmittances and reflectances of the entire wavelength selective polarizer illustrated in FIG. 1C according to the fifth embodiment.

FIG. 12A is a graph of transmittances and reflectances of a multilayer structure according to a sixth embodiment, and FIG. 12B is a graph of transmittances and reflectances of the entire wavelength selective polarizer illustrated in FIG. 1C according to the sixth embodiment.

FIG. 13 is a graph of transmittances and reflectances of the wavelength selective polarizer illustrated in FIG. 1C according to a seventh embodiment.

FIG. 14 is a graph of transmittances and reflectances of the wavelength selective polarizer illustrated in FIG. 1D according to an eighth embodiment.

### DESCRIPTION OF THE EMBODIMENTS

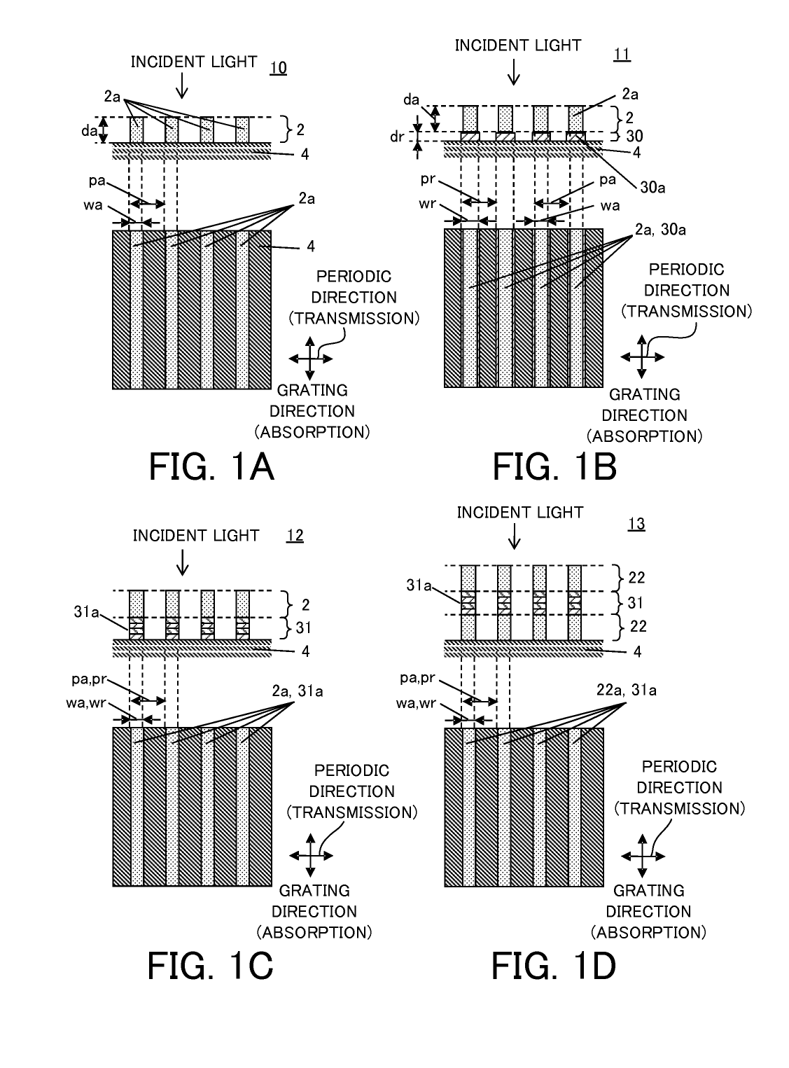

FIG. 1A is a sectional view (top) and a plane view (bottom) of a wavelength selective polarizer 10 according to this embodiment. The wavelength selective polarizer 10 includes a substrate 4 that is transparent to a visible wavelength band (with a wavelength of 430 nm to 650 nm), and an absorption layer 2 having a linear grating structure formed on the substrate 4. The absorption layer 2 includes a plurality of structures 2a each having a longitudinal direction in a grating direction (first direction), which are structured similarly to one another. Each structure 2a has a rectangular section orthogonal to the grating direction, and has the same line width.

The plurality of structures 2a are arranged at regular intervals with a grating period pa that is shorter than the shortest wavelength in the visible wavelength band along a horizontal or periodic direction (second direction or predetermined direction) in FIG. 1A which is orthogonal to the grating direction and parallel to the surface of the substrate, on which the absorption layer 2 is formed. The absorption layer 2 is made of a colored composition that absorbs light in a first wavelength band in the visible wavelength band, and transmits light in a second wavelength band different from the first wavelength band in the visible wavelength band.

Due to the shape anisotropy of the absorption layer 2, the absorption anisotropy occurs in the first wavelength band. In other words, this embodiment can provide a wavelength selective polarizer configured to transmit a polarization component of the light in the first wavelength band in the periodic direction of the linear grating structure, to absorb a polarization component of the light in the first wavelength band in the grating direction, and to transmit the light in the second wavelength band different from the first wavelength band irrespective of a polarization direction.

Since it is unnecessary for the wavelength selective polarizer according to this embodiment to use the stretched polymer film, this wavelength selective polarizer has a good selecting freedom of a base material. In addition, this wavelength selective polarizer can be made of a highly heat resistant material, and thus has a more improved durability than that of the conventional wavelength selective polarizer.

The colored composition is made of a material in which a wavelength characteristic of an attenuation coefficient significantly changes in the visible wavelength band. In particular, the material has a maximum absorbed wavelength λap in the visible wavelength band. A wavelength selective polarizer having a high wavelength selectivity can be provided when the maximum extinction coefficient kmax and the minimum extinction coefficient kmin satisfy the following conditional expression.

A coefficient representing how much light incident upon a medium is absorbed in the medium is referred to as an absorption coefficient, and is expressed as I₀e^{-αz} where I₀ is the pre-incident light intensity, I is the post-incident light intensity, and z is a propagation distance of incident light. An extinction coefficient k is expressed as α=(4πk)/λ, where α is an absorption coefficient, and λ is the wavelength of the light.

0.1<kmax−kmin<0.5 (1)

The maximum extinction coefficient kmax falls within the first wavelength band, and the minimum extinction coefficient kmin falls within the second wavelength band. This can be calculated, for example, by the transmittance and the film thickness in JP 2007-147738. When the value does not satisfy the lower limit of the expression (1), the wavelength selectivity of the wavelength selective polarizer becomes undesirably low. When the value does not satisfy the upper limit of the expression (1), the material selectivity becomes undesirably narrow.

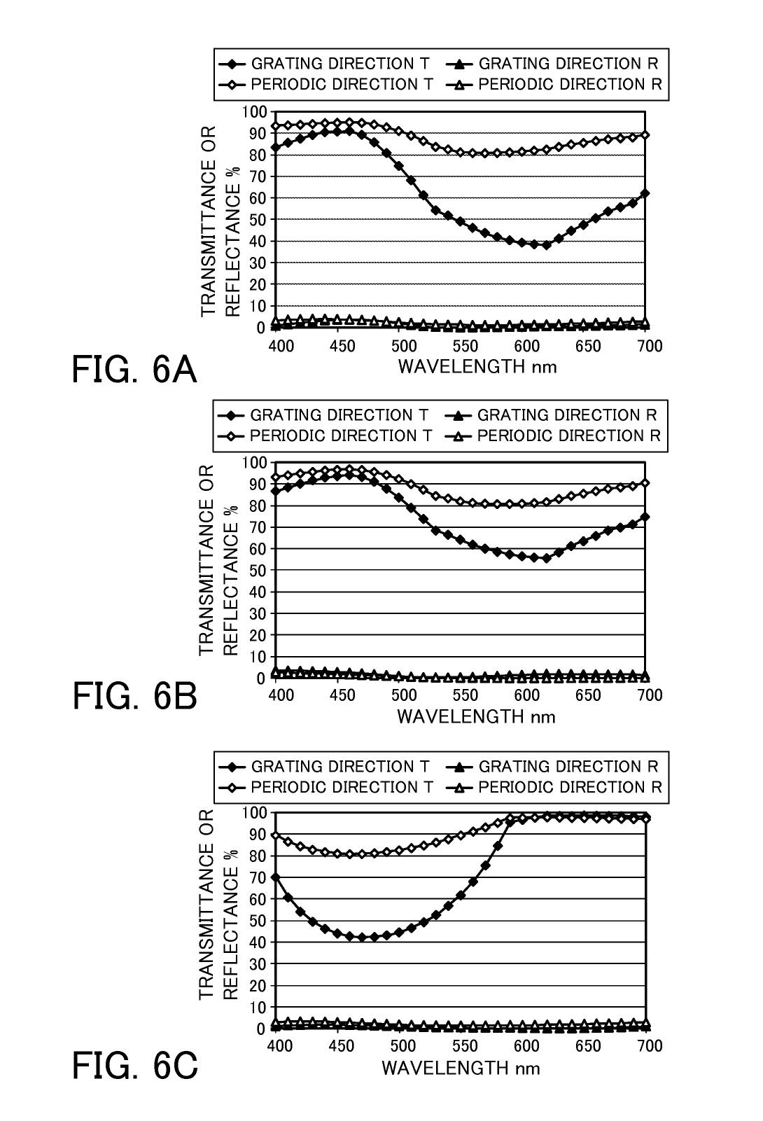

FIG. 3 is a graph for explaining a transition wavelength bandwidth of the wavelength selective polarizer 10, where an abscissa axis denotes a wavelength (nm) and an ordinate axis denotes a transmittance or reflectance (%). FIG. 3 is a transmittance of the polarization component in a grating direction, as illustrated in FIGS. 6A-6C. The “transition wavelength bandwidth” means a band between a wavelength that corresponds to the maximum transmittance−10% (Tmax−10%) in a second wavelength band (blue wavelength band) and a wavelength that corresponds to the minimum transmittance+10% (Tmin+10%) in the first wavelength band (red wavelength band).

As the transition wavelength bandwidth becomes narrower, the wavelength selectivity of the wavelength selective polarizer becomes higher. The transition wavelength bandwidth is 100 nm or wider according to the polarizer disclosed in JP 2008-216957, while the transition wavelength bandwidth according to this embodiment is as narrow as 60 nm and provides a high wavelength selectivity. In other words, this embodiment can provide, as illustrated in FIG. 3, a wavelength selective polarizer having a high wavelength selectivity because the transition wavelength bandwidth is equal to or narrower than 100 nm between the first wavelength band and the second wavelength band.

The colored composition of the absorption layer 2 is made of a resin composition in which dyes or pigments are dispersed, and provides a desired characteristic. In the other words, the absorption layer is configured of a resin composition in which color materials are dispersed. The color materials mean dyes or pigments. The dye or pigment can be selected by considering the heat resistance property, the light resistance property, the dispersion property in the resin, and the stableness.

More specifically, a monoazo material, a diazo material, a condensed diazo material, a phthalocyanine material, and an anthraquinone material, and a lake material, etc. and a mixture of two or more of them can be selected as a desired material. A nanoparticle diameter of the pigment can be selected by considering the spectrum transmittance characteristic, the dispersion, the evenness, and the stableness. In general, the resin composition in which the pigments are dispersed has a higher durability and thus is more suitable. The base resin material in which the pigments are dispersed can use photosensitive resin (color resist) represented by the photo-polymerization acrylic material and photocrosslinked polyvinyl alcohol material and non-photosensitive resin represented by the polyimide material.

The absorption layer 2 can be manufactured by the screen printing method, the inkjet method, the photolithography method, the nanoimprinting method, etc. The absorption layer 2 has a grating period smaller than the wavelength, and the photolithography method and the nanoimprinting method are more suitable.

When the base resin material in which the pigments are dispersed is made of the photosensitive material, the linear grating shape can be manufactured by a simple manufacturing process in which an exposure and a development follow an application of the material. When the base resin material in which the pigments are dispersed is made of the non-photosensitive material, the linear grating shape can be manufactured by performing an application with resist, an exposure, and a development so as to pattern the resist, and then etching. This method needs more manufacturing steps than that of the method using the photosensitive material, but can select a base material that has a good coloring characteristic and a high heat resistance property.

The linear grating structure can be directly manufactured by the nanoimprinting method onto the resin composition in which the dyes or pigments are dispersed. In that case, although the material that has a good coloring characteristic and a high heat resistance property can be selected, a material that has a higher moldability suitable for the nanoimprinting method may be selected.

An average filling factor FFa of the absorption layer 2 may satisfy the following conditional expression.

0.05<FFa<0.5 (2)

Herein, the filling factor is defined as a ratio (wa/pa) of a line width wa of each structure 2a in the periodic direction to a grating period pa of the absorption layer 2 in the periodic direction, and the average filling factor FFa is defined as an average of the filling factors in the entire area of the absorption layer. When the value does not satisfy the upper limit in the expression (2), the extinction ratio undesirably lowers in the first wavelength band of the wavelength selective polarizer. When the value does not satisfy the lower limit in the expression (2), a line width of the absorption layer in the wavelength selective polarizer becomes narrower, the grating height increases so as to maintain the extinction ratio, and it is undesirably difficult to manufacture the device.

FIG. 1A illustrates an ideal linear structure. An angle of the vertical wall may incline and become tapered depending on the manufacturing method. An uneven shape appears depending on the type of the material. Nevertheless, the above effect(s) can be obtained as long as the average filling factor may satisfy the expression (2).

FIG. 1B is a sectional view (top) and a plane view (bottom) of another wavelength selective polarizer according to this embodiment. The wavelength selective polarizer 11 includes the substrate 4 that is transparent to the light in the visible wavelength band, the absorption layer 2 having the linear grating structure formed on the substrate 4, and a thin film layer 30 having a linear grating structure arranged between the absorption layer 2 and the substrate 4.

The thin film layer 30 includes a plurality of thin films 30a each having the grating direction as the longitudinal direction and each being similarly structured. Each thin film 30a has a rectangular section orthogonal to the grating direction, and the same line width.

The plurality of thin films 30a are arranged along the periodic direction at regular intervals with a grating period pr that is shorter than the shortest wavelength of the visible wavelength band. The linear grating structure of the transparent material arranged with a period shorter than the wavelength serves as the anisotropic medium referred to as a structural birefringence, and the refractive indexes in the periodic and grating directions can be approximated by the effective medium theory (“EMT”).

The thin film layer 30 transmits the polarization component in the periodic direction in the whole visible wavelength band, reflects the polarization component in the grating direction in the first wavelength band, and transmits the polarization component in the grating direction in the second wavelength band. The thin film layer 30 is made of a highly refractive index material, and a difference between its refractive index np in the periodic direction and the refractive index of the substrate is so small that the thin film layer 30 exhibits a high transmittance to the entire visible wavelength band. On the other hand, a difference between the refractive index ng of the thin film layer 30 in the grating direction and the refractive index of the substrate is so large that reflections occur. When the film thickness of the thin film layer 30 is adjusted, the thin film layer 30 can transmit light in the second wavelength band, and reflects light in the first wavelength band. Thus, the highly refractive index material is suitable for the thin film layer 30. The refractive index n1 of the thin film layer 30 to light with a wavelength of 550 nm may satisfy the following condition.

1.8<n1<2.5 (3)

When the value does not satisfy the lower limit in the expression (3), it is difficult to transmit the light in the second wavelength band and to reflect the light in the first wavelength band. When the value does not satisfy the upper limit in the expression (3), a material selecting range becomes narrower.

By arranging the absorption layer 2 on the incident side as illustrated in FIG. 1B, the absorption layer 2 can absorb the polarization component in the first wavelength band in the grating direction, and the thin film layer 30 can reflect the unabsorbed transmitting component so as to enable the absorption layer 2 to reabsorb that component. Hence, the extinction ratio can be more improved when the absorption layer 2 is arranged on the incident side than when the thin film layer 30 is arranged on the incident side.

The average filling factor FFr of the thin film layer 30 may satisfy the following conditional expression.

0.05<FFr<0.7 (4)

Herein, the filling factor is defined as a ratio (wr/pr) of a line width wr of each thin film 30a in the periodic direction to a grating period pr of the thin film layer 30 in the periodic direction. The average filling factor FFr is an average of the filling factors in the entire area of the thin film layer. When the value does not satisfy the upper limit in the expression (4), the wavelength selectivity in the grating direction becomes narrower and more reflections are likely to occur in the periodic direction. When the value does not satisfy the lower limit in the expression (4), the filling factor becomes too low to stabilize the thin film layer 30. The average filling factor FFa of the absorption layer 2 may be the same as or different from the average filling factor FFr of the thin film layer 30.

The following conditional expression may be satisfied so as to widen the wavelength selectivity in the visible wavelength band in the grating direction.

1/2<n(TE)×d/λrp<7/4 (5)

Herein, d denotes a grating height of the thin film layer, λrp denotes a maximum reflected wavelength of the polarization component in the grating direction of the thin film layer 30, and n(TE) denotes an effective refractive index of the structural birefringence in the grating direction expressed below.

n(TE)={nₘₐₜ²×FFr+nₐᵢᵣ²×(1−FFr)}^{1/2} (6)

Herein, nₘₐₜ denotes a refractive index of a material, and nₐᵢᵣ denotes a refractive index of air.

The following conditional expression may be satisfied so as to reduce the reflections with the substrate 4 in the periodic direction.

0≦|n(TM)−ns|<0.3 (7)

Herein, ns is a refractive index of the substrate 4, and n(TM) is an effective refractive index of the structural birefringence in the periodic direction, expressed below.

n(TM)=[nₘₐₜ²×nₐᵢᵣ²×(1−FFr)/{nₐᵢᵣ²×FFr−nₘₐₜ²×(1−FFr)}]^{1/2} (8)

FIG. 1C is a sectional view (top) and a plane view (bottom) of still another wavelength selective polarizer 12 according to this embodiment. The wavelength selective polarizer 12 includes the substrate 4 that is transparent to the light in the visible wavelength band, the absorption layer 2 having the linear grating structure formed on the substrate 4, and a multilayer structure 31 arranged between the absorption layer 2 and the substrate 4.

The multilayer structure 31 includes a plurality of similarly structured, multilayer films 31a each having the grating direction as the longitudinal direction. Each multilayer film 31a has a rectangular section orthogonal to the grating direction, and the same line width.

The plurality of multilayer films are arranged along the periodic or horizontal direction at regular intervals with a grating period pr that is shorter than the shortest wavelength in the visible wavelength band. Each multilayer film 31a is made by alternately laminating a thin film layer having a high refractive index and a thin film layer having a low refractive index on each other.

Due to a small refractive index difference in the periodic direction, the multilayer structure 31 has a high transmittance to the whole visible wavelength band. On the other hand, due to a large refractive index difference in the grating direction, the multilayer structure 31 causes reflections. When the film thickness is adjusted, the multilayer structure 31 can transmit light in the second wavelength band and reflect light in the first wavelength band. The multilayer structure 31 having a linear grating structure can further improve the extinction ratio and the wavelength selectivity in the first wavelength band of the wavelength selective polarizer.

The average filling factor of the multilayer structure 31 may satisfy the following conditional expression.

0.05<FFr<0.5 (9)

Herein, the filling factor is defined as a ratio (wr/pr) of a line width wr of each multilayer film 31a in the periodic direction to a grating period pr of each multilayer layer 31 in the periodic direction. The average filling factor FFr is an average of the filling factors in the entire multilayer structure 31. When the value does not satisfy the upper limit in the expression (9), more reflections are likely to occur of the polarization component in the periodic direction in the multilayer structure 31 undesirably. When the value does not satisfy the lower limit in the expression (9), the filling factor becomes too low to stabilize the multilayer structure 31. The average filling factor FFa of the absorption layer 2 may be equal to or different from the average filling factor FFr of the multilayer structure 31.

The following expression may be satisfied so as to reduce the reflections in the periodic direction.

0≦|nH(TM)−nL(TM)|<0.3 (10)

Herein, nH(TM) and nL(TM) are effective refractive indexes of the high refractive index thin film layer and the low refractive index thin film layer.

The following conditional expressions may be satisfied where nH is a refractive index of the material of the thin film layer having the high refractive index, and nL is a refractive index of the material of the thin film layer having the low refractive index.

1.8<nH<2.5 (11)

1.2<nL<1.6 (12)

When the expressions (11) and (12) are not satisfied, the transmittance of the polarization component in the periodic direction undesirably lowers.

The thin film layer is made of oxide or fluoride, and a proper material can be selected. A specific example of the material may contain TiO₂, Nb₂O₅, Ta₂O₅, ZnO, HfO₂, and ZrO₂ for the high refractive index material, and SiO₂ and MgF₂ for the low refractive index material.

The thin film layer and the multilayer structure may be manufactured by the vacuum evaporation method, the sputtering method, or the sol-gel method, and the linear conditional structure can be formed by the photolithography method. In forming on the multilayer structure 31 the absorption layer 2 that is made of a photosensitive resin composition (color resist) in which the pigments are dispersed, the multilayer structure 31 and the absorption layer 2 are formed, then the absorption layer 2 is exposed and developed, and next the multilayer structure 31 is formed by etching with the absorption layer 2 as a mask. The absorption layer 2 may be exposed and developed by the nanoimprinting method.

The following conditional expression may be satisfied where λap is a maximum absorbed wavelength in the material of the absorption layer 2, and λrp is a maximum reflected wavelength of a polarization component in the grating direction of the thin film layer or the multilayer structure.

|λap−λrp|<50 nm (13)

When the expression (13) is not satisfied, the reflected light increases in the first wavelength band in the grating direction and the extinction ratio lowers undesirably.

The wavelength selective polarizer 11 having the absorption layer 2 and the thin film layer 30 can obtain a desired transmittance and reflectance by properly adjusting the absorption layer 2 and the thin film layer 30. The wavelength selective polarizer 12 having the absorption layer 2 and the multilayer structure 31 can obtain a desired transmittance and reflectance by properly adjusting the absorption layer 2 and the multilayer structure 31. As the absorption layer 2 is made thicker or as the number of layers is increased, the extinction ratio of the transmitting light can be improved.

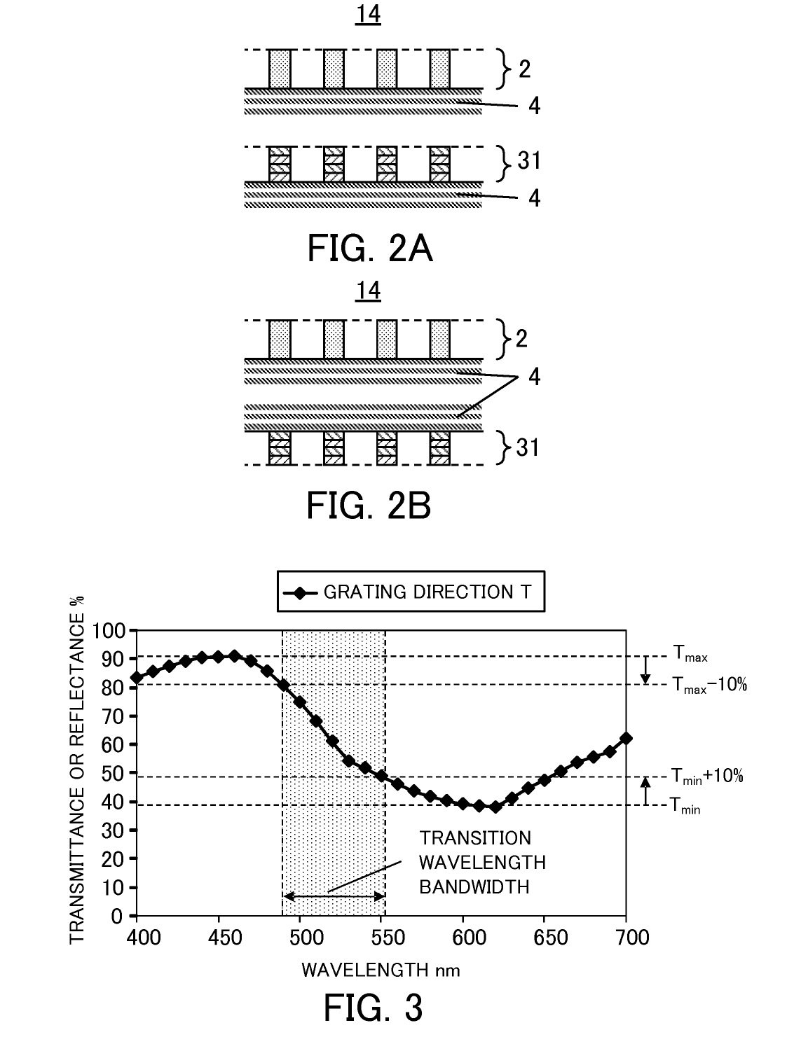

While the absorption layer 2 is directly laminated on the thin film layer 30 or the multilayer structure 31 are directly laminated, this lamination is not always necessary because the effective interaction between them is not utilized. Thus, the absorption layer 2 and the thin film layer 30 or the multilayer structure 31 may be formed on different substrates as illustrated in FIG. 2A, or they may be formed on both sides of the same substrate as illustrated in FIG. 2B.

FIG. 1D is a sectional view (top) and a plane view (bottom) of yet another wavelength selective polarizer 13 according to this embodiment. The wavelength selective polarizer 13 includes the substrate 4 that is transparent to the light in the visible wavelength band, two absorption layers 22 each having a linear grating structure formed on the substrate 4, and a multilayer structure 31 arranged between the two absorption layers 22. This configuration can reduce reflected light incident from the substrate side, and thus the ghost when the wavelength selective polarizer is applied to the projection-type display apparatus. The absorption layers on both sides may have the same thickness or different thicknesses.

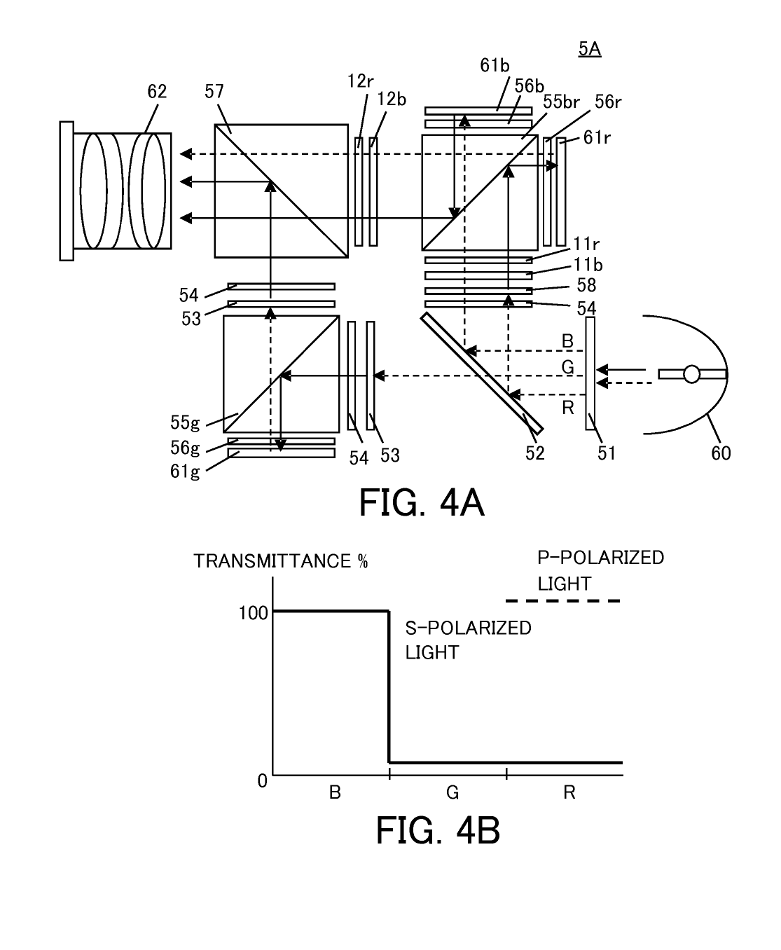

FIG. 4A is an optical path diagram of a projection-type display apparatus (liquid crystal projector) 5A using a wavelength selective polarizer according to this embodiment.

Arrows illustrated in FIG. 4A illustrate an optical path of a ray of red light R (with a wavelength of 580 nm to 650 nm), a ray of green light G (with a wavelength of 510 nm to 570 nm), and a ray of blue light B (with a wavelength of 430 nm to 490 nm) in a white display. A solid line denotes S-polarized light (having a polarization state in which an electric field oscillates in a direction perpendicular to the paper plane), and a broken line denotes P-polarized light (having a polarization state in which an electric field oscillates in the paper plane).

The projection-type display apparatus 5 includes a light source 60, an illumination optical system, a color separating/composing system, reflection-type liquid crystal light modulators 61b, 61r, and 61g, and a projection optical system 62.

The light source 60 is, for example, a high-pressure mercury lamp having a reflector, or another light source, such as a laser light source. The illumination optical system includes an UV-IR cutoff filter, an integrator, a condenser lens, and a polarization converter 51 configured to align the polarization directions of non-polarized light with one another.

The color separating/composing system includes a dichroic mirror 52, a half phase shifter 53, a polarizer 54, a wavelength selective polarizer according to this embodiment, polarization beam splitters (“PBSs”) 55g and 55br, optical phase compensators 56b, 56r, and 56g, a color combiner 57, and a wavelength selective phase shifter 58. The wavelength selective polarizer may use any one of the structures illustrated in FIGS. 1A to 1D, but is implemented as the wavelength selective polarizers 11r, 11b, and 12r illustrated in FIGS. 1B and 1C in FIG. 4A. The color combiner 57 is a combiner configured to compose a plurality of colored light fluxes with one another. The projection optical system 62 projects image light onto a target plane, such as a screen.

In operation, white light emitted from the high-pressure mercury lamp is reflected by a reflector, converted into approximately collimated light fluxes, and emitted. The illumination optical system illuminates the reflection-type liquid crystal light modulators 61b, 61r, and 61g, and the polarization converter 51 aligns the polarization light fluxes of the illumination light with the P-polarized light fluxes.

The dichroic mirror 52 separates light in the visible wavelength band into transmitting light and reflected light, and more specifically transmits the green light and reflects the blue light and the red light. The P-polarized green light G that has transmitted through the dichroic mirror 52 passes the half phase shifter 53 and is converted into S-polarized light, transmits through the polarizer 54 so as to improve the polarization degree, and enters the PBS 55g. The PBS separates the light into transmitting light and reflected light depending upon the polarization state.

The green light G reflected on a polarization splitting plane of the PBS 55g transmits through the optical phase compensator 56g, enters the reflection-type liquid crystal display (“LCD”) element 61g for green (“G modulator 61g”), and is modulated. In the white display, the modulated light is emitted as the P-polarized light, and transmits through the PBS 55g. The green light G that has transmitted the PBS 55g transmits through the half phase shifter 53, is converted into S-polarized light, transmits through the polarizer 54 to improve the polarization degree, is reflected on the color combiner 57 having a characteristic illustrated in FIG. 4B, and is projected by the projection optical system 62. In FIG. 4B, the abscissa axis denotes a wavelength, and an ordinate axis denotes a transmittance.

The blue light B reflected on the dichroic mirror 52 transmits through the polarizer 54 to improve the polarization degree, transmits through the wavelength selective phase shifter 58 while its P-polarized state is maintained, transmits through the wavelength selective polarizers 11b and 11r, and enters the PBS 55br. The wavelength selective phase shifter converts a polarization direction in a specific wavelength band by 90°, and the wavelength selective phase shifter 58 rotates the polarization direction of the red light by 90°.

The blue light B that has passed the PBS 55br transmits through the optical phase compensator 56b, enters the reflection-type liquid crystal display element 61b for blue (“B modulator 61b”), and is modulated. The wavelength selective polarizer 11b (or a polarizer for a blue wavelength) transmits the polarization component in the periodic direction of the light in the blue wavelength band, absorbs the polarization component in the grating direction of the light in the blue wavelength band, and transmits the light in the red wavelength band irrespective of the polarization direction. The grating direction of the linear grating of the absorption layer 2 in the wavelength selective element 11b is set to the S-polarized light direction (or a perpendicular direction to the paper plane) to absorb the S-polarized component of the blue light B. The wavelength selective polarizer 11r (or a polarizer for a red wavelength) transmits the polarization component in the periodic direction of the light in the red wavelength band, absorbs the polarization component in the grating direction of the light in the red wavelength band, and transmits the light in the blue wavelength band irrespective of the polarization direction.

The grating direction of the linear grating structure of the absorption layer 2 in the wavelength selective polarizer 11r is set to the P-polarized direction (in a direction within the paper plane) to absorb a P-polarized component of the red light R. When the light transmits through the wavelength selective polarizers 11b and 11r, the P-polarized light component of the red light can be cut off which has not been rotated by the wavelength selective phase shifter 58 and is to enter the B modulator 61b.

In the white display, the light modulated by the B modulator 61b is emitted as the S-polarized light, and reflected on the polarization splitting plane of the PBS 55br. The blue light B reflected on the PBS 55br transmits through the wavelength selective polarizers 12b and 12r, transmits through the color combiner 57 having the characteristic illustrated in FIG. 4B, and is projected by the projection optical system 62.

The wavelength selective polarizer 12b is the same polarizer for the blue wavelength as the wavelength selective polarizer 11b, but the grating direction of the linear grating structure of the absorption layer is set to the S-polarized light direction (or a direction within the paper plane) so as to absorb the P-polarized light component of the blue light B.

The wavelength selective polarizer 12r is the same polarizer for the red wavelength as the wavelength selective polarizer 11r, but the grating direction of the linear grating structure of the absorption layer is set to the S-polarized light direction (or the direction perpendicular to the paper plane) to absorb the S-polarized component of the red light R.

When the light transmits through the wavelength selective polarizers 12b and 12r, the P-polarized light component of the blue light B can be cut off which has leaked from the B modulator 61b, the optical phase compensator 56b, and the PBS 55br. As a result, this configuration can improve the contrast of the blue light in the black display and the color purity of the blue light in the white display.

The red light R reflected on the dichroic mirror 52 transmits through the polarizer 54 and improves the polarization degree. Then, the red light R is converted into S-polarized light by the wavelength selective phase shifter 58, transmits through the wavelength selective phase shifter 58, then transmits through the wavelength selective polarizers 11b and 11r, and enters the PBS 55br.

The red light R reflected on the PBS 55br transmits through the optical phase compensator 56r, enters the reflection-type LCD element 61r for red (“R modulator 61r”), and is modulated. When the red light R transmits through the wavelength selective polarizers 11b and 11r, the S-polarized component of the blue light can be cut off which is to enter the R modulator 61r for red and has rotated by the wavelength selective phase shifter 58.

In the white display, the light modulated by the R modulator 61r is emitted as P-polarized light, and transmits through the polarization splitting plane of the PBS 55br. The red light R that has transmitted through the PBS 55br transmits the wavelength selective polarizers 12b and 12r, transmits through the color combiner 57 having the characteristic illustrated in FIG. 4B, and is projected by the projection optical system 62.

When the light transmits through the wavelength selective polarizers 12b and 12r, the S-polarized light component of the red light R can be cut off which has leaked from the R modulator 61r, the optical phase compensator 56r, and the PBS 55br. As a result, this configuration can improve the contrast of the red light in the black display and the color purity of the red light in the white display.

This embodiment provides the wavelength selective polarizer between the PBS 55br and the color combiner 57 or between the PBS 55br and the wavelength selective phase shifter (color select) 58, and improves the contrast and durability of the projection-type display apparatus.

In particular, the wavelength selective polarizer 12b configured to absorb the light in the blue wavelength band and the wavelength selective polarizer 12r configured to absorb the light in the red wavelength band are provided between the color combiner 57 and the PBS 55br that is configured to emit the blue light and the red light. This configuration can improve the light detection performance of the blue light and the red light in the black display, and thus the contrast. In addition, the color purity in the white display can be improved by arranging the wavelength selective polarizer 11b configured to absorb the light in the blue wavelength band and the wavelength selective polarizer 11r configured to absorb the light in the red wavelength band between the PBS 55br and the wavelength selective phase shifter 58, and by detecting the leak light from the wavelength selective plate 58.

Since the wavelength selective polarizer according to this embodiment does not have to use a stretched polymer film, a wide selecting range of a base material can be maintained and a material having a high heat resistance property can be used. Therefore, the wavelength selective polarizer according to this embodiment has a higher durability than that of the conventional wavelength selective polarizer, providing a higher durability of the projection-type display apparatus.

While the wavelength selective polarizer for the blue wavelength band and the wavelength selective polarizer for the red wavelength band are configured as separate devices in FIG. 4A, they can be stacked as a parallel-cross structure on the same substrate or on both sides of the same substrate. Alternatively, they can be produced on the PBS or the wavelength selective phase shifter.

The polarizer 54, which is provided only on the optical path of the green light, can use a general polarizer having no wavelength selectivity, or the wavelength selective polarizer according to the first to eighth embodiments which is modified for the green wavelength band.

The wavelength selective polarizer for the blue wavelength band and the wavelength selective polarizer for the red wavelength band are provided between the PBS 55br and the color combiner 57 and between the PBS 55br and the wavelength selective phase shifter 58, but all of these components are not always necessary. The necessary component is properly selected depending on the performance and purpose of the desired projection-type display apparatus.

FIG. 4A illustrates a structural example of the projection-type display apparatus using three reflection-type LCDs, and the number of reflection-type LCDs, an arrangement of each optical element, a wavelength band, an optical path configuration, etc. can be properly changed and a suitable wavelength selective polarizer can be used.

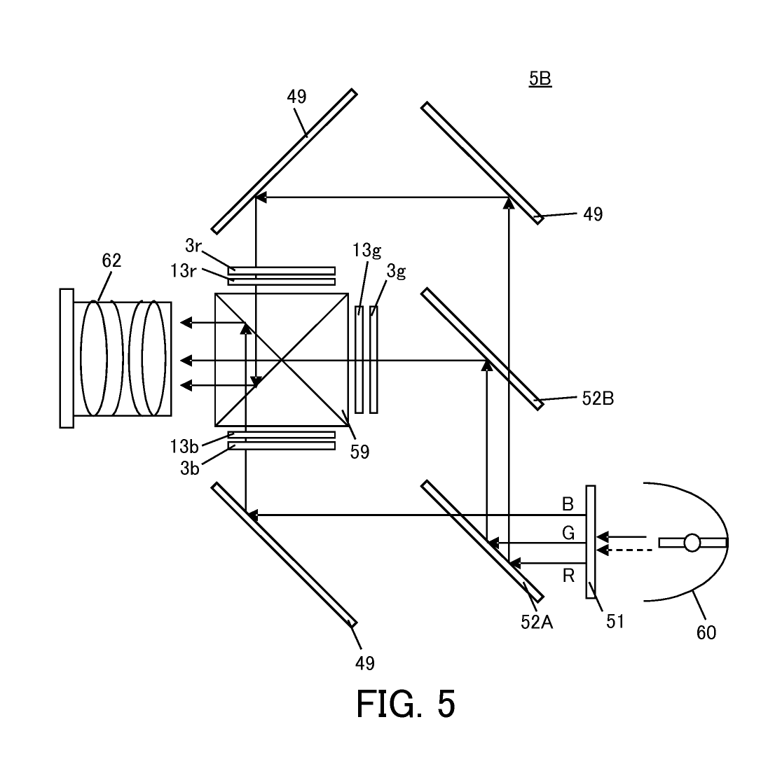

FIG. 5 is an optical path diagram of another projection-type display apparatus (liquid crystal projector) 5B using a wavelength selective polarizer according to this embodiment. The projection-type display apparatus 5B includes a light source 60, an illumination optical system, a mirror 49, a color separating/composing system, transmission-type light modulators 3b, 3r, and 3g, and a projection optical system 62. The light source 60, the illumination optical system, and the projection optical system 62 are similar to those elements in FIG. 4A.

The color separating/composing system includes a dichroic mirror 52A configured to separate the light in the visible wavelength band into transmitting light and reflected light, a composing prism (or combiner) 59 configured to compose the modulated light fluxes, and wavelength selective polarizers 13r, 13g, and 13b according to this embodiment.

The dichroic mirror 52A transmits the blue light B and reflects the green light G and the red light R. The blue light B is reflected and deflected by the mirror 49, enters the transmission-type light modulator 3b, and is modulated. The green light G is reflected and deflected by the dichroic mirror 52B, enters the transmission-type light modulator 3g, and is modulated. The red light R transmits the dichroic mirror 52B, is reflected and deflected by two mirrors 49, enters the transmission-type light modulator 3r, and is modulated.

In the white display, the modulated blue light B, modulated green light G, and modulated red light R transmit the wavelength selective polarizer 13b for blue, the wavelength selective polarizer 13g for green, and the wavelength selective polarizer 13r for red, respectively, are composed by the composing prism 59, and projected on a target plane by the projection optical system 62.

This embodiment provides the wavelength selective polarizer between each of the transmission-type light modulators 3r, 3g, and 3r and the composing prism 59, and improves the contrast.

Each transmission-type LCD element includes an incident side polarizer, a liquid crystal layer, and an exit side polarizer. The wavelength selective polarizer according to this embodiment is applicable to each of the incident side polarizer and the exit side polarizer.

Since the wavelength selective polarizer according to this embodiment does not have to use a stretched polymer film, a wide selecting range of a base material can be maintained and a material having a high heat resistance property can be used. Therefore, the wavelength selective polarizer according to this embodiment has a higher durability than that of the conventional wavelength selective polarizer, and improves the durability of the projection-type display apparatus.

### First Embodiment

The first embodiment uses the wavelength selective polarizer 10 illustrated in FIG. 1A.

The absorption layer 2 is made of a material that transmits the light in the blue wavelength band (with a wavelength of 430 nm to 490 nm) and absorbs the light in the red wavelength band (with a wavelength of 580 nm to 650 nm). This material is a colored composition generally known as a material for a color filter. A difference between a maximum extinction coefficient in the red wavelength band and a minimum extinction coefficient in the blue wavelength band of this colored composition is 0.3. The maximum absorbed wavelength λap is 620 nm. As a result, the wavelength selective polarizer transmits a polarization component in the periodic direction of the light in the red wavelength band, absorbs the polarization component in the grating direction of the light in the red wavelength band, and transmits the light in the blue wavelength band irrespective of its polarization direction. The grating period pa is 200 nm. The average filling factor FFa (absorption layer line width wa/grating period pa) is 0.2. The grating height da is 400 nm.

The grating height da can be properly adjusted with a desired transmittance. The medium on the incident side is air, and the refractive index of the substrate glass is 1.5. These conditions are common to the following other embodiments.

FIG. 6A is a result of transmittances and reflectances calculated by the rigorous coupled-wave analysis (“RCWA”) of polarization components in the grating and periodic directions of the wavelength selective polarizer according to the first embodiment. T denotes the transmittance, and R denotes the reflectance. A black rhomb denotes the transmittance in the grating direction. A black triangle denotes the reflectance in the grating direction. A white rhomb denotes the transmittance in the grating direction. A white triangle denotes the reflectance in the periodic direction. These definitions are true of the other embodiments and comparative examples. The abscissa axis denotes the wavelength (nm), and the ordinate axis denotes the transmittance or reflectance (%).

The incident light is incident from the absorption layer 2 side. The wavelength selective polarizer (the polarizer for the red wavelength) is obtained which transmits the polarization component in the periodic direction of the light in the red wavelength band, absorbs the polarization component in the grating direction of the light in the red wavelength band, and transmits the light in the blue wavelength band irrespective of the polarization direction.

### Second Embodiment

Similar to the first embodiment, the second embodiment uses the wavelength selective polarizer 10 illustrated in FIG. 1A, but is different from the first embodiment in that the average filling factor FFa is 0.4 and the grating height da is 140 nm.

FIG. 6B illustrates a result of the transmittances and reflectances calculated by the RCWA of the polarization components in the grating and periodic directions of the wavelength selective polarizer according to the second embodiment. The extinction ratio of the second embodiment is lower than that of the first embodiment, but the wavelength selective polarizer (the polarizer for the red wavelength) is obtained which transmits the polarization component in the periodic direction of the light in the red wavelength band, absorbs the polarization component in the grating direction of the light in the red wavelength band, and transmits the light in the blue wavelength band irrespective of the polarization direction.

### Comparative Example

The comparative example uses the wavelength selective polarizer 10 illustrated in FIG. 1A, similar to the first and second embodiments, but is different from the first and second embodiments in that the average filing factor FFa is 0.6 and the grating height da is 60 nm. The comparative example has the same device structure as that of each of the first and second embodiments but the average filling factor FFa is different.

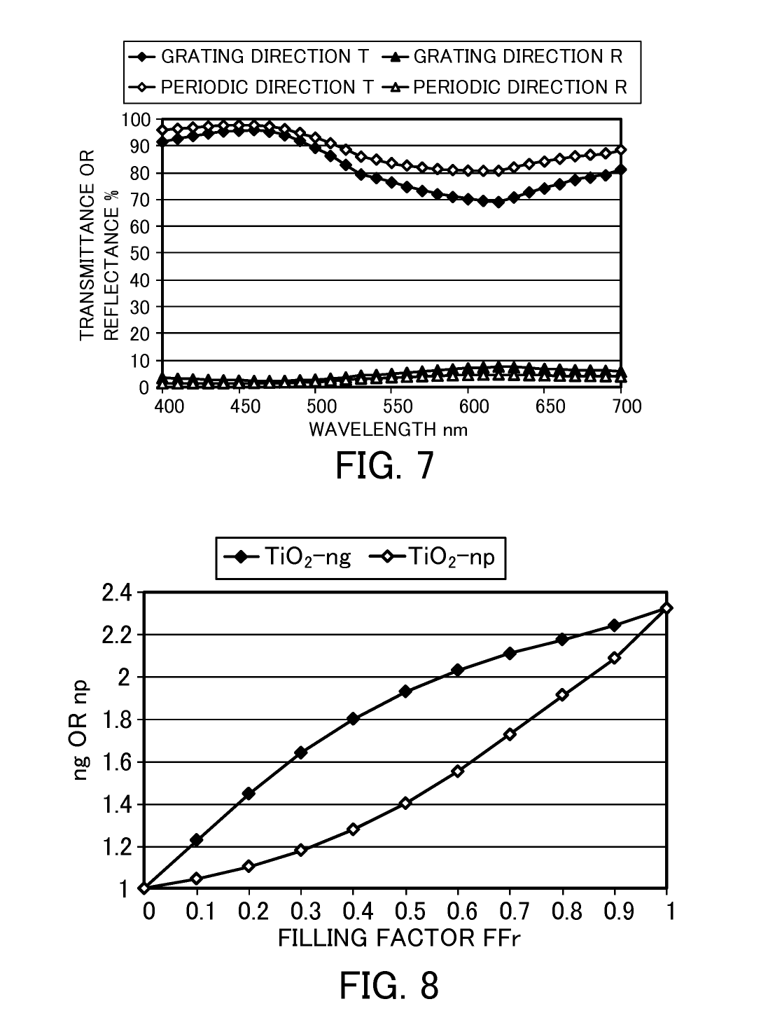

FIG. 7 illustrates a result of transmittances and reflectances calculated by the RCWA of the polarization components in the grating and periodic directions of the wavelength selective polarizer according to the comparative example. In comparison with the first and second embodiments, it is understood that the extinction ratio of the first wavelength band is lower and the wavelength selective polarizer according to the comparative example has a difficulty in serving as the polarizer. It is understood from the first and second embodiments and the comparative example that the average filling factor FFa of the absorption layer 2 needs to satisfy the upper limit of the expression (1) so as to improve the extinction ratio of the first wavelength band in the wavelength selective polarizer.

### Third Embodiment

Similar to the first and second embodiments, the third embodiment uses the wavelength selective polarizer 10 illustrated in FIG. 1A, but is different from the first and second embodiments in the wavelength band of the absorption layer 2. The absorption layer 2 is made of a material that transmits the light in the red wavelength band and absorbs the light in the blue wavelength band. This material is a colored composition generally known as a material for a color filter. A difference between a maximum extinction coefficient in the blue wavelength band and a minimum extinction coefficient in the red wavelength band of this colored composition is 0.2, and the maximum absorbed wavelength λap is 470 nm. As a result, the wavelength selective polarizer is obtained which transmits a polarization component in the periodic direction of the light in the blue wavelength band, absorbs the polarization component in the grating direction of the light in the blue wavelength band, and transmits the light in the red wavelength band irrespective of its polarization direction. More specifically, the grating period pa is 200 nm, the average filling factor FFa is 0.2, and the grating height da is 400 nm.

FIG. 6C illustrates a result of transmittances and reflectances calculated by the RCWA of the polarization components in the grating and periodic directions of the wavelength selective polarizer according to the third embodiment. The wavelength selective polarizer (the polarizer for the blue wavelength) is obtained which transmits the polarization component in the periodic direction of the light in the blue wavelength band, absorbs the polarization component in the grating direction of the light in the blue wavelength band, and transmits the light in the red wavelength band irrespective of the polarization direction.

### Fourth Embodiment

The fourth embodiment uses a wavelength selective polarizer 11 illustrated in FIG. 1B.

Similar to the first and second embodiments, the absorption layer 2 has a linear grating structure arranged in the periodic direction at regular intervals with a grating period pa that is smaller than the shortest wavelength in the visible wavelength band, transmits the light in blue wavelength band, and absorbs the light in the red wavelength band. A difference between a maximum extinction coefficient in the red wavelength band and a minimum extinction coefficient in the blue wavelength band of this colored composition is 0.3. The grating period pa is 200 nm. The average filling factor FFa is 0.2. The grating height da is 400 nm.

The thin film layer 30 is made of TiO₂ as a dielectric thin material that is transparent to light in the visible wavelength band. The grating period pr of the thin film layer 30 is 200 nm, and has a structural birefringence illustrated in FIG. 8 with a refractive index np in the periodic direction and a refractive index ng in the grating direction to light with a wavelength of 550 nm. The average filling factor FFr is 0.5, and the grating height dr is 245 nm. In FIG. 8, the abscissa axis denotes the average filling rate FFr, and the ordinate axis denotes ng or np.

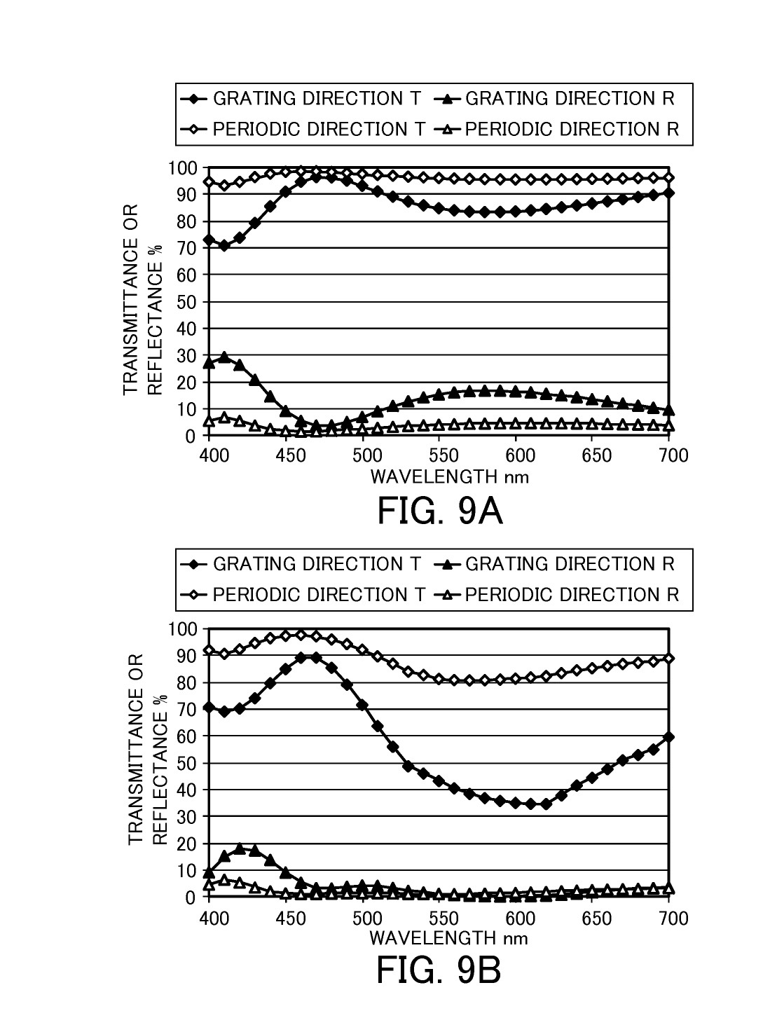

FIG. 9A illustrates a result of transmittances and reflectances calculated by the RCWA of the polarization components in the grating and periodic directions of the thin film layer 30. Due to a small difference between np and the refractive index of the substrate, the thin film layer 30 has a high transmittance over the visible wavelength band. Reflections occur in the grating direction because of a large difference between ng and the refractive index of the substrate. By adjusting the film thickness, the thin film 30 can transmit light in the blue wavelength band (in particular with a wavelength of 450 nm to 490 nm) and reflect light in the red wavelength band (in particular with a wavelength of 580 nm to 630 nm).

FIG. 9B illustrates a result of transmittances and reflectances calculated by the RCWA of the polarization components in the grating and periodic directions of the wavelength selective polarizer according to the fourth embodiment. The wavelength selective polarizer (the polarizer for the red wavelength) is obtained which transmits the polarization component in the periodic direction of the light in the red wavelength band, absorbs the polarization component in the grating direction of the light in the red wavelength band, and transmits the light in the blue wavelength band irrespective of the polarization direction. It is understood that the extinction ratio of the polarization component in the red wavelength band in the grating direction improves in comparison with FIG. 6A.

### Fifth Embodiment

The fifth embodiment uses the wavelength selective polarizer 12 illustrated in FIG. 1C.

Similar to the first, second, and fourth embodiments, the absorption layer 2 has a linear grating structure arranged in the periodic direction at regular intervals with a grating period pa smaller than the shortest wavelength in the visible wavelength band, transmits the light in the blue wavelength band, and absorbs the light in the red wavelength band. A difference between a maximum extinction coefficient in the red wavelength band and a minimum extinction coefficient in the blue wavelength band of the colored composition is 0.3. The grating period pa is 200 nm. The average filling factor FFa is 0.2. The grating height da is 400 nm.

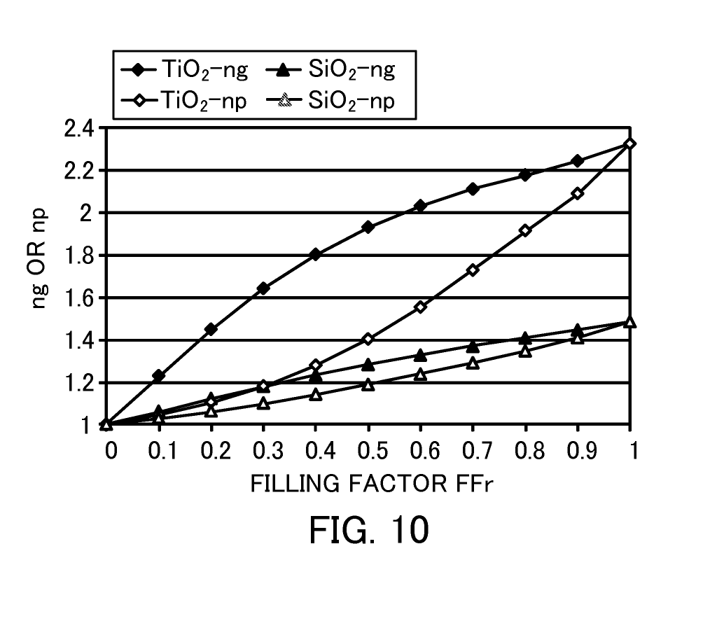

The multilayer structure 31 is made of TiO₂ and SiO₂ as dielectric thin materials that are transparent to the light in the visible wavelength band. The grating height of TiO₂ is 105 nm, the grating height of SiO₂ is 130 nm, and TiO₂ and SiO₂ are alternately laminated by fourteen layers. The grating period pr is 200 nm. The average filling factor FFr is 0.2. A structural birefringence is illustrated in FIG. 10 with a refractive index np in the periodic direction and a refractive index ng in the grating direction to the light with a wavelength of 550 nm.

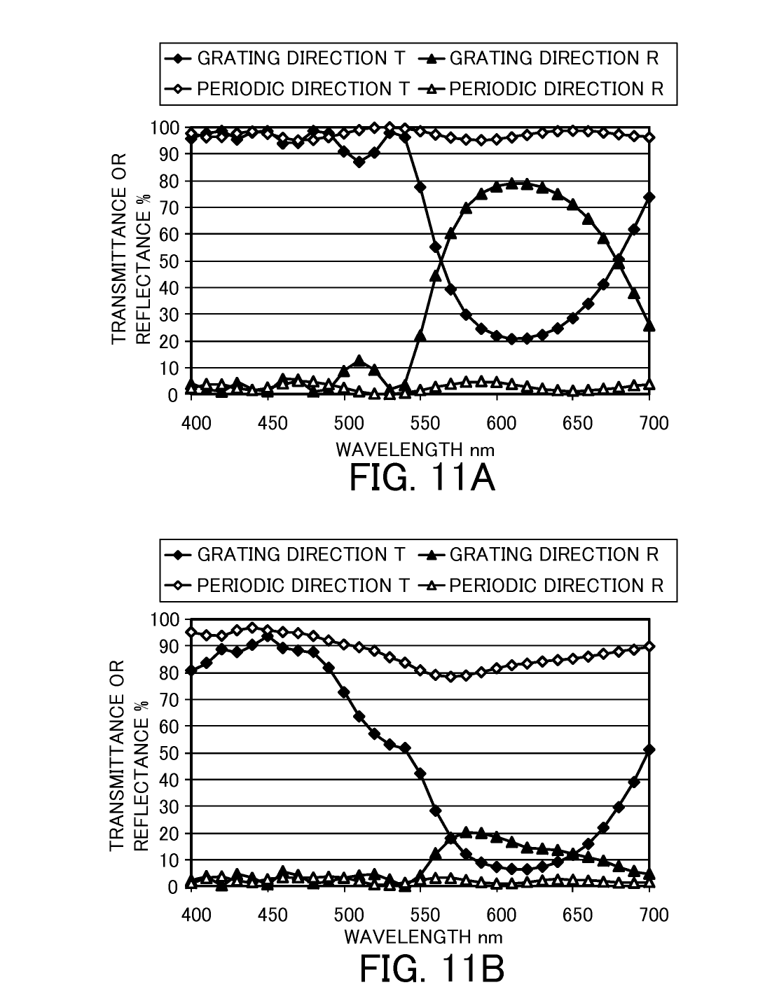

FIG. 11A illustrates a result of transmittances and reflectances calculated by the RCWA of the polarization components in the grating and periodic directions of the multilayer structure 31. Due to a small difference between TiO₂-np and SiO₂-np in the periodic direction, the multilayer structure 31 exhibits a high transmittance over the visible wavelength band. On the other hand, multilayer reflections occur in the grating direction because of a large difference between TiO₂-np and SiO₂-np. By adjusting the film thickness, the multilayer structure 31 can transmit the light in the blue wavelength band, and reflect the light in the red wavelength band. Due to the multilayer reflections, the reflectance, the extinction ratio, and wavelength selectivity can improve in comparison with FIG. 9A.

The multilayer structure 31 is made by repetitively laminating the thin film having the high refractive index and the thin film having the low refractive index by equal thicknesses, and ripples occur due to the multilayer interference as in the blue wavelength band in FIG. 11A. A quantity of ripples can be reduced by optimizing the respective film thicknesses.

FIG. 11B illustrates a result of transmittances and reflectances calculated by the RCWA of the polarization components in the grating and periodic directions of the wavelength selective polarizer according to the fifth embodiment. The wavelength selective polarizer (the polarizer for the red wavelength) is obtained which transmits the polarization component in the periodic direction of the light in the red wavelength band, absorbs the polarization component in the grating direction of the light in the red wavelength band, and transmits the light in the blue wavelength band irrespective of the polarization direction. It is understood that the extinction ratio of the polarization component in the red wavelength band in the grating direction improves in comparison with the fourth embodiment.

### Sixth Embodiment

The sixth embodiment uses the wavelength selective polarizer 12 illustrated in FIG. 1C, but is different from the fifth embodiment in the number of layers in the multilayer structure 31. TiO₂ and SiO₂ are alternately laminated by eight layers. Other conditions are similar to those of the fifth embodiment, such as the difference between the maximum extinction coefficient in the red wavelength band and the minimum extinction coefficient in the blue wavelength band, the grating period pa, the average filling factor FFa, the grating height da, the material of the multilayer structure 31, the grating period pr, the average filling factor FFr, the grating height of TiO₂, and the grating height of SiO₂.

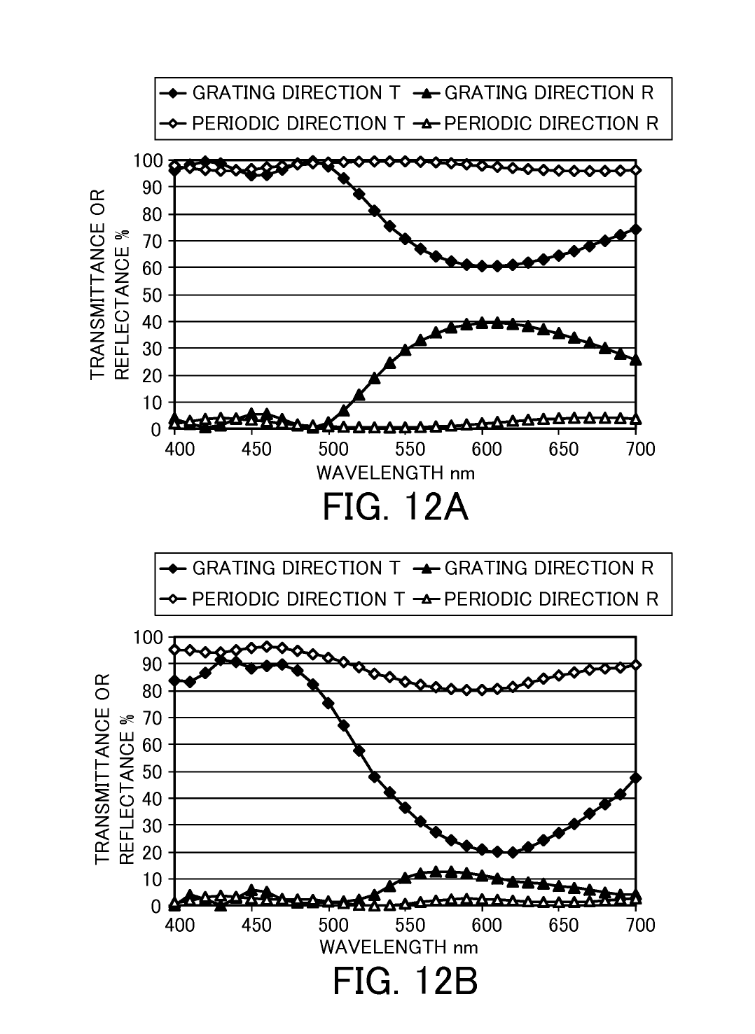

FIG. 12A illustrates a result of transmittances and reflectances calculated by the RCWA of the polarization components in the grating and the periodic directions of the multilayer structure 31. The reflectance is lower than that of the fifth embodiment because the multilayer structure 31 has a smaller number of layers.

FIG. 12B illustrates a result of transmittances and reflectances calculated by the RCWA of the polarization components in the grating and periodic directions of the wavelength selective polarizer according to the sixth embodiment. The wavelength selective polarizer (the polarizer for the red wavelength) is obtained which transmits the polarization component in the periodic direction of the light in the red wavelength band, absorbs the polarization component in the grating direction of the light in the red wavelength band, and transmits the light in the blue wavelength band irrespective of the polarization direction. In comparison with the fifth embodiment, the extinction ratio of the first wavelength band is lower, but the reflectance is lower.

The wavelength selective polarizer according to the sixth embodiment can obtain a desired transmittance and reflectance by appropriately adjusting the absorption layer and the multilayer structure. The extinction ratio of the transmitted light can be improved by making the absorption layer thicker and by increasing the number of layers in the multilayer structure as in the fifth embodiment, and the reflectance can be reduced by decreasing the number of layers in the multilayer structure as in the sixth embodiment.

### Seventh Embodiment

The seventh embodiment uses the wavelength selective polarizer 12 illustrated in FIG. 1C, but is different from the fifth embodiment in the material of the absorption layer 2 and the number of layers in the multilayer structure 31. Similar to the third embodiment, the material of the absorption layer 2 transmits the light in the red wavelength band and absorbs the light in the blue wavelength band. A difference is 0.2 between the maximum extinction coefficient in the red wavelength band and the minimum extinction coefficient in the blue wavelength band. Some other conditions are similar to those of the fifth embodiment, such as the grating period pa, the average filling factor FFa, the grating height da, the material of the multilayer structure 31, the grating period pr, and the average filling factor FFr. The grating height of TiO₂ is 80 nm. The grating height of SiO₂ is 100 nm. TiO₂ and SiO₂ are alternately laminated by ten layers.

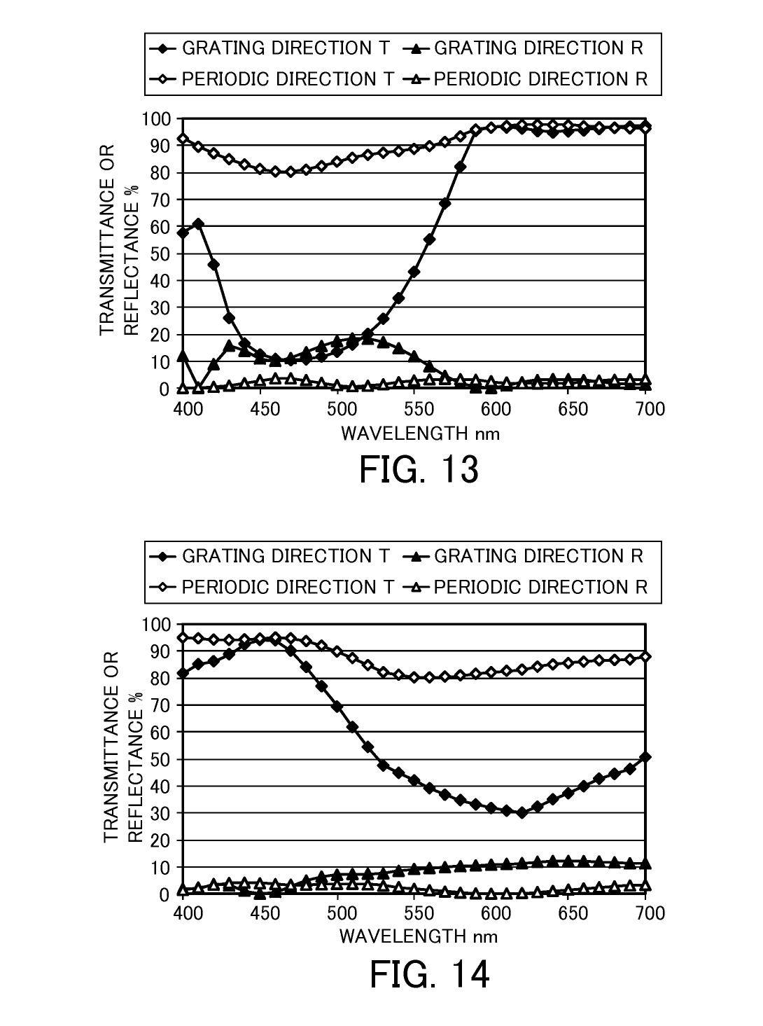

FIG. 13 illustrates a result of transmittances and reflectances calculated by the RCWA of the polarization components in the grating and periodic directions of the wavelength selective polarizer according to the seventh embodiment. The wavelength selective polarizer (the polarizer for the blue wavelength) is obtained which transmits the polarization component in the periodic direction of the light in the blue wavelength band, absorbs the polarization component in the grating direction of the light in the blue wavelength band, and transmits the light in the red wavelength band irrespective of the polarization direction. The wavelength band can be properly adjusted by changing the material of the absorption layer 2 and the wavelength band of the multilayer structure 31. A fine adjustment of the wavelength is also available.

### Eighth Embodiment

The eighth embodiment uses the wavelength selective polarizer 13 illustrated in FIG. 1D.

Each of the absorption layers 22 on both sides is made of a material that transmits the light in the blue wavelength band and absorbs the light in the red wavelength band. A difference is 0.3 between the maximum extinction coefficient in the red wavelength band and the minimum extinction coefficient in the blue wavelength band. The grating period pa is 200 nm. The average filling factor FFa is 0.2. The grating height da is 200 nm. The multilayer structure 31 is made of TiO₂ and SiO₂, the grating height of TiO₂ is 105 nm, and the grating height of SiO₂ is 130 nm. TiO₂ and SiO₂ are alternately laminated by five layers. The grating period pr is 200 nm, and the average filling factor FFr is 0.2.

FIG. 14 illustrates a result of transmittances and reflectances calculated by the RCWA of the polarization components in the grating and periodic directions of the wavelength selective polarizer according to the eighth embodiment. The wavelength selective polarizer (the polarizer for the red wavelength) is obtained which transmits the polarization component in the periodic direction of the light in the red wavelength band, absorbs the polarization component in the grating direction of the light in the red wavelength band, and transmits the light in the blue wavelength band irrespective of the polarization direction.

When light enters the wavelength selective polarizer 12 illustrated in FIG. 1C from the substrate side, reflections occur when the light enters the multilayer structure 31. When the wavelength selective polarizer is used for the projection-type display apparatus, this light undesirably causes a ghost. Since the absorption layers of the eighth embodiment are provided on both sides of the multilayer structure, the reflected light can be equalized for light incident from the substrate side. Since the eighth embodiment provides a symmetrical structure, the characteristic for light incident from the substrate side is similar to that illustrated in FIG. 14.

The present invention provides an absorption-type wavelength selective polarizer, an optical system, and a projection-type display apparatus, which can have a high durability and a high wavelength selectivity.

The wavelength selective polarizer according to this embodiment is applicable to the projection-type display apparatus, such as a liquid crystal projector, and its optical system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-027916, filed Feb. 17, 2014, which is hereby incorporated by reference herein in its entirety.

What is claimed is:

1. A wavelength selective polarizer comprising:
a substrate that is transparent to light in a visible wavelength band; and
an absorption layer configured of a resin composition in which color materials are dispersed and formed on the substrate,
wherein the absorption layer includes a plurality of structures that are structured similarly to one another, the plurality of structures being arranged in a predetermined direction with a period shorter than a shortest wavelength in the visible wavelength band,
wherein where a longitudinal direction of each of the plurality of structures is set to a first direction, the predetermined direction is a second direction that is orthogonal to the first direction and parallel to a surface of the substrate, on which the absorption layer is formed, and
wherein a material of the absorption layer satisfies the following condition:
0.1<kmax−kmin<0.5
where kmax is a maximum extinction coefficient obtained to light in a first wavelength band in the visible wavelength band, and kmin is a minimum extinction coefficient obtained to light in a second wavelength band in the visible wavelength band different from the first wavelength band.

2. The wavelength selective polarizer according to claim 1, wherein a bandwidth is 100 nm or narrower between a wavelength of a maximum transmittance−10% in the second wavelength band and a wavelength of a minimum transmittance+10% in the first wavelength band.

3. The wavelength selective polarizer according to claim 1, wherein the following condition is satisfied:
0.05<FFa<0.5
where FFa is an average filling factor of the absorption layer which is an average ratio of a width of each structure in the second direction relative to the period of the absorption layer in the second direction over the absorption layer.

4. The wavelength selective polarizer according to claim 1, further comprising a thin film layer that includes a plurality of thin films that are structured similarly to one another, the plurality of thin films being arranged in the second direction by a period shorter than the shortest wavelength in the visible wavelength band,
wherein each thin film is located between each structure of the absorption layer and the substrate, and
wherein the following condition is satisfied:
1.8<n1<2.5
where n1 is a refractive index of the thin film layer to light of a wavelength of 550 nm.

5. The wavelength selective polarizer according to claim 4, wherein the following condition is satisfied:
0.05<FFr<0.7
where FFr is an average filling factor of the thin film layer which is an average ratio of a width of each thin film in the second direction relative to the period of the thin film layer in the second direction over the thin film layer.

6. The wavelength selective polarizer according to claim 4, wherein the following condition is satisfied

|λap−λrp|<50 nm
where λap is a maximum absorbed wavelength of the material of the absorption layer, and λrp is a maximum reflected wavelength of a polarization component in the first direction of the thin film layer.

7. The wavelength selective polarizer according to claim 1, further comprising a multilayer structure that includes a plurality of multilayer films that are structured similarly to one another, the plurality of multilayer films being arranged in the second direction with a period shorter than the shortest wavelength in the visible wavelength band,
wherein each multilayer film is made by alternately laminating a thin film layer having a high refractive index and a thin film layer having a low refractive index.

8. The wavelength selective polarizer according to claim 7, wherein the following conditions are satisfied:
1.8<nH<2.5; and
1.2<nL<1.6,
where nH is a refractive index of a material of the thin film layer having the high refractive index to light with a wavelength of 550 nm, and nL is a refractive index of a material of the thin film layer having the low refractive index to the light with the wavelength of 550 nm.

9. The wavelength selective polarizer according to claim 7, wherein the following condition is satisfied:

|λap−λrp|<50 nm,
where λap is a maximum absorbed wavelength of a material of the absorption layer, and λrp is a maximum reflected wavelength of a polarization component in the first direction of the multilayer structure.

10. The wavelength selective polarizer according to claim 7, wherein the absorption layer and the multilayer structure are laminated.

11. The wavelength selective polarizer according to claim 1, wherein the color materials are dyes or pigments and each structure of the absorption layer is made of a resin composition in which dyes or pigments are dispersed.

12. An optical system comprising a wavelength selective polarizer that includes a substrate that is transparent to light in a visible wavelength band, and an absorption layer that is colored and formed on the substrate,
wherein the absorption layer includes a plurality of structures that are structured similarly to one another, the plurality of structures being arranged in a predetermined direction with a period shorter than a shortest wavelength in the visible wavelength band,
wherein where a longitudinal direction of each of the plurality of structures is set to a first direction, the predetermined direction is a second direction that is orthogonal to the first direction and parallel to a surface of the substrate, on which the absorption layer is formed, and
wherein a material of the absorption layer satisfies the following condition:
0.1<kmax−kmin<0.5
where kmax is a maximum extinction coefficient obtained to light in a first wavelength band in the visible wavelength band, and kmin is a minimum extinction coefficient obtained to light in a second wavelength band in the visible wavelength band different from the first wavelength band.

13. A projection-type display apparatus comprising an optical system that includes a wavelength selective polarizer, wherein the wavelength selective polarizer includes a substrate that is transparent to light in a visible wavelength band, and an absorption layer that is colored and formed on the substrate,
wherein the absorption layer includes a plurality of structures that are structured similarly to one another, the plurality of structures being arranged in a predetermined direction with a period shorter than a shortest wavelength in the visible wavelength band,
wherein where a longitudinal direction of each of the plurality of structures is set to a first direction, the predetermined direction is a second direction that is orthogonal to the first direction and parallel to a surface of the substrate, on which the absorption layer is formed, and
wherein a material of the absorption layer satisfies the following condition:
0.1<kmax−kmin<0.5
where kmax is a maximum extinction coefficient obtained to light in a first wavelength band in the visible wavelength band, and kmin is a minimum extinction coefficient obtained to light in a second wavelength band in the visible wavelength band different from the first wavelength band.

14. The projection-type display apparatus according to claim 13, wherein the optical system includes:
a wavelength selective phase shifter configured to rotate a polarization direction of a specific wavelength band in the visible wavelength band by 90°; and
a polarization beam splitter configured to separate light into transmitting light and reflected light depending upon a polarization state of the light, and
wherein the wavelength selective polarizer is arranged between the wavelength selective phase shifter and the polarization beam splitter.

15. The projection-type display apparatus according to claim 13, wherein the optical system comprising:
a polarization beam splitter configured to separate light into transmitting light and reflected light depending upon a polarization state of the light; and
a combiner configured to compose a plurality of colored light fluxes,
wherein the wavelength selective polarizer is arranged between the wavelength selective phase shifter and the combiner.

16. The projection-type display apparatus according to claim 13, further comprising a transmission-type light modulator configured modulate a colored light flux,
wherein the optical system includes:
a combiner configured to compose a plurality of colored light fluxes modulated by the transmission-type light modulator; and
wherein the wavelength selective polarizer is arranged between the transmission-type light modulator and the combiner.
